(19) United States
(12) Patent Application Publication
(10) Pub. No.: US 2008/0273499 A1
(43) Pub. Date: Nov. 6, 2008

(54) Packet Forwarding Method, Path Reconstrucitng Method and State Transition Method For Avoiding Packet Loss During Handover

(75) Inventors: Hong Seok Jeon, Daejeon-city (KR); Jung Hoon Jee, Daejeon-city (KR); Jong Hwa Yi, Daejeon-city (KR); Hyeong Ho Lee, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics &Telecommunications Research Institute, Daejeon (KR)

(21) Appl. No.: 12/089,820

(22) PCT Filed: Nov. 30, 2005
(86) PCT No.: PCT/KR2005/004056

§ 371 Date: Apr. 10, 2008

(30) Foreign Application Priority Data
Oct. 10, 2005 (KR) 10-2005-0094895

(51) Int. Cl. H04Q 7/00; H04L 12/56

(52) U.S. Cl. 370/331; 370/389

(57) ABSTRACT

Provided is a method of packet forwarding over partial mesh network to avoid packet loss during handover. The method includes: based on first trigger information of a layer 2 obtained when a mobile node (MN) moves from a domain of a currently connected first BS to another domain, expecting a second BS of the domain to which the MN moves; if the first BS acquires second trigger information of the layer 2 indicating a disconnection between the first BS and the MN, forwarding packets destined for the MN to the second BS through the links; and if the second BS buffers the packets forwarded from the first BS and third trigger information of the layer 2 indicating a connection between the second BS and the MN, transferring the buffered packets to the MN.

### TECHNICAL FIELD

The present invention relates to a method of forwarding packets during handover, and more particularly, to methods of forwarding packets through links between a plurality of base stations, resetting a packet path, and transiting states of the base stations to avoid packet loss during handover.

### BACKGROUND ART

U.S. Patent Publication No. 2004-0203740 discloses a conventional handover method, “Hybrid Wireless Access Bridge and Mobile Access Router System and Method” wherein a mobile node performs handover without a new Internet Protocol (IP) address when it moves between subnets providing a seamless service to the mobile node without additional operations such as Mobile IPv4. All base stations are connected to a central router that provides a connection point with the Internet. Therefore, when the mobile node moves between subnets, the central router controls new paths of packets destined for the mobile node so that the seamless service is provided to the mobile node without an assistance of the Mobile IPv4 after handover is performed. Since the Mobile IPv4 is not used, a packet transmission delay is reduced, thereby providing seamless service to the mobile node.

Korean Patent Publication No. 2005-0023194 discloses another conventional handover method, “Handover Method of Preventing Packet Loss in Portable Internet”. This patent relates to handover method for a portable connection terminal of mobility in WiBro Portable Internet. Connection information on the portable connection terminal located in a first base station connector and a first packet connection router is transferred to a second base station connector and a second packet connection router to which the portable connection terminal moves. A tunnel is generated between the first and second packet connection routers. And packets included in the first base station connector are forwarded to the first packet connection router and transferred to the second base station connector through the tunnel. So the second base station connector transfers the packets to the portable connection terminal.

As another conventional handover method, “Low Latency Handoffs in Mobile IPv4” standards in progress by the Mobile IPv4 working group of Internet Engineering Task Force (IETF) wherein a new network to which a mobile node moves is expected based on layer 2 trigger information and packets are forwarded, thereby reducing packet loss due to handover. However, the layer 2 trigger information is not reliable due to an uncertain characteristic of a wireless media, and a packet might be lost due to an erroneous expectation of the new network.

### DISCLOSURE OF THE INVENTION

The present invention provides a method of forwarding packets between base stations respectively connected to each other via links to avoid packet loss during handover.

The present invention also provides a method of forwarding packets by resetting a previously set forwarding path to avoid packet loss during handover due to an erroneous expectation of base stations.

The present invention also provides a method of resetting a packet path by terminating a previously set forwarding path to avoid packet loss during handover.

The present invention also provides a method of transiting states between base stations that forward packets through links to avoid packet loss during handover.

According to an aspect of the present invention, there is provided a method of forwarding packets in a wireless Internet network in which base stations (BS) of neighboring domains are one-to-one connected via links to avoid packet loss, the method comprising: (a) based on first trigger information of a layer 2 obtained when a mobile node (MN) moves from a domain of a currently connected first BS to another domain, expecting a second BS of the domain to which the MN moves; (b) transmitting a first message including expectation information to BSs of neighboring domains; (c) if the first BS acquires second trigger information of the layer 2 indicating a disconnection between the first BS and the MN, forwarding packets destined for the MN to the second BS through the links; and (d) if the second BS buffers the packets forwarded from the first BS and third trigger information of the layer 2 indicating a connection between the second BS and the MN, transferring the buffered packets to the MN.

According to another aspect of the present invention, there is provided a the determi method of forwarding packets in a wireless Internet network in which BSs of neighboring domains are one-to-one connected via links to avoid packet loss due to an erroneous expectation, the method comprising: (a) based on first trigger information of a layer 2 obtained when a mobile node (MN) moves from a domain of a currently connected first BS to another domain, expecting a second BS of the domain to which the MN moves; (b) transmitting a first message including expectation information to BSs of neighboring domains; (c) if the first BS acquires second trigger information of the layer 2 indicating a disconnection between the first BS and the MN, forwarding packets destined for the MN to the second BS through the links; and (d) if a third BS neighboring both the first BS and the second BS acquires third trigger information of the layer 2 indicating a connection between the third BS and the MN, requesting the second BS to forward the buffered packets based on information on the second BS included in the first message and receiving the buffered packets.

According to another aspect of the present invention, there is provided a method of resetting a path of packets forwarded via at least one BS through links in a wireless Internet network in which BSs of neighboring domains are one-to-one connected via links, the method comprising: (a) when an MN moves from a domain including a first BS to another domain including a second BS, transmitting a fourth message including a registration request message of the MN and an IP address of the second BS to an HA through the second BS; (b) the HA transmitting the fourth message to the first BS corresponding to a previous care-of-address (CoA); and (c) the first BS and BSs on a packet forwarding path to the MN comparing the IP address of the second BS included in the fourth message with their IP addresses, if the IP addresses are different from each other, terminating the forwarding path to the MN and transmitting the fourth message to a next BS on the forwarding path, and, if the IP addresses are identical to each other, disregarding the fourth message.

According to another aspect of the present invention, there is provided a method of transiting states of BSs in a wireless Internet network in which BSs of neighboring domains are one-to-one connected via links, the method comprising: (a) based on first trigger information of a layer 2 obtained when an MN moves from a domain of a first serving BS that provides service to the MN to another domain, expecting a second BS of the domain to which the MN moves, and transiting the expected second Bs to an active BS state; (b) setting third BSs neighboring the second active BS and the first serving BS to passive BS states; (c) if second trigger information of the layer 2 indicating a disconnection between the MN and the first serving BS is acquired, transiting the first serving BS to an anchor BS state to forward packets destined for the MN to the second active BS; and (d) if third trigger information of the layer 2 indicating a connection between the MN and the second active BS is acquired, transiting the third passive BSs to normal BS states.

### BRIEF DESCRIPTION OF THE DRAWINGS

The above and other features and advantages of the present invention will become more apparent by describing in detail embodiments thereof with reference to the attached drawings in which:

FIG. 1 illustrates the structure of a wireless Internet network to which the present invention is applied;

FIG. 2 is a flowchart illustrating overall procedures to avoid packet loss due to handover according to an embodiment of the present invention;

FIG. 3 illustrates state transition of BSs according to the movement of a mobile node (MN) according to an embodiment of the present invention;

FIG. 4 illustrates a method of expanding a packet forwarding path when an MN does not move to an expected BS but other BS according to an embodiment of the present invention;

FIG. 5 illustrates operations of transmitting/receiving packets without resetting a packet path through Mobile IPv4 according to an embodiment of the present invention;

FIG. 6 illustrate operations of terminating a packet forwarding path after resetting a packet path through Mobile IPv4 according to an embodiment of the present invention.

### BEST MODE FOR CARRYING OUT THE INVENTION

The present invention will now be described more fully with reference to the accompanying drawings, in which exemplary embodiments of the invention are shown.

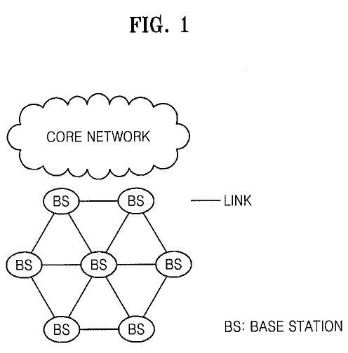

FIG. 1 illustrates the structure of network to which the present invention is applied. Referring to FIG. 1, the wireless Internet network includes a plurality of domains each domain including a base station (BS). The BSs of neighboring domains are respectively connected to each other through a plurality of links, and communicate with each other in a one-hop distance without a router. The links are not used to operate an existing protocol. According to the present invention, newly defined messages or packets destined for a mobile node (MN) are transmitted through the links. The BSs of non-neighboring domains are connected through Internet protocol (IP) tunneling.

Each of the BSs can include information on neighboring BSs using a network manager or a candidate access router discover (CARD) RFC 4066, and manage a plurality of routing tables to forward packets to an MN that moves to a neighboring BS.

Each of the BSs can update the routing tables by the message defined in the present invention. Each of the routing tables includes information on an IP address of an MN, packets destined for the MN, and a link to which the packets are forwarded from the MN. Each of the BSs has various states, for example, a serving BS, an active BS, a passive BS, an anchor BS, and a normal BS, according to the movement of the MN.

Each of the BSs includes an IP router and a plurality of access points (AP) under the IP router. The MN is connected to the IP router through the APs. Each of the BSs or the IP router may serve as a foreign agent (FA).

When the wireless Internet network uses Ethernet-based media such as a wireless local area network (WLAN), the IP address and an Ethernet address are required to transfer packets. Therefore, when the BSs transfer forwarded packets to the MN, the Ethernet address of the MN is required and transferred by the message defined in the present invention.

When handover is not performed through the mobile IPv4 after the MN moves to another domain and forwards packets, an Ethernet address of a default router (identical to the BS of the present invention) is required. When the MN moves a new BS and handover is not performed through the mobile IPv4, an Ethernet address of a previous default router is used as an Ethernet address of a packet forwarded by the MN, so that the MN does not receive the packet through the new BS.

In order to receive packets from the MN that does not perform handover through the mobile IPv4, a common Ethernet address is set as a source Ethernet address to transfer the FA or an agent advertisement message (AAM) which is included in each of the BSs, and the default router receives packets having the common Ethernet address set as a destination Ethernet address. Each of the domains has a different common Ethernet address that can be used as an Ethernet address of interface which is a wireless section of a specific BS.

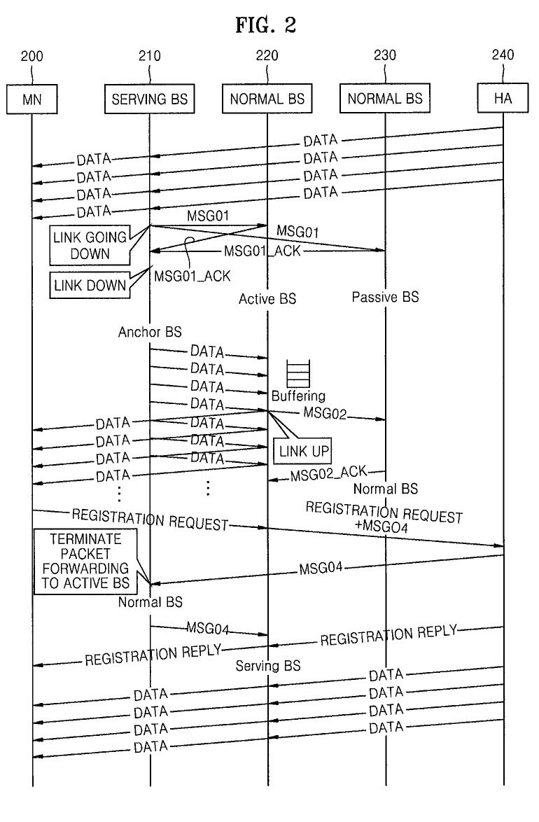

FIG. 2 is a flowchart illustrating a method of forwarding packets to avoid packet loss during handover according to an embodiment of the present invention. Referring to FIG. 2, a serving BS 210 (that is registered to a home agent (HA) as a care-of-address (CoA) of an MN through the mobile IPv4) provides a service to an MN 200. When the MN 200 moves to another domain, the serving BS 210 acquires link going down trigger information from a layer 2 and expects which BS provides the service to the MN 200 based on the acquired link going down trigger information.

The serving BS 210 sends a first message MSG01 to a BS 220 that is expected to provide a service to the MN 200 and to a movement candidate BS 230. Both the BS 200 and the movement candidate BS 230 are normal BSs. The movement candidate BS 230 neighbors the BS 220 and the serving BS 210 where the link going down trigger information is acquired.

The BS 220 and the movement candidate BS 230 which receive the first message MSG01 send a first message acknowledgement MSG01_ACK and transit to an active BS state and a passive BS state, respectively, from the normal BS states. In the active BS state, the BS 220 is expected to provide a service to the MN 200 based on the link going down trigger information. The passive BS state refers to the movement candidate BS 230.

The first message MSG01 includes address information of layer 2 (e.g., a media access control (MAC) address) and address information of layer 3 (e.g., an IP address) on the MN 200, profile information on the service connection of the MN 200, and information on whether a BS is an active BS or a passive BS. The first message acknowledgement MSG01_ACK is a response message informing of whether the BS 220 and the movement candidate BS 230 receive the first message MSG01.

When the MN 200 completely disconnects a link from the serving BS 210, the serving BS 210 acquires the link down trigger information from the layer 2. After receiving the link down trigger information, the serving BS 210 transits to an anchor BS state, and forwards packets destined for the MN 200 to the active BS 220.

The active BS 220 buffers the packets forwarded from the anchor BS 210. The anchor BS 210 does not forward packets destined for the MN 200 to its wireless section but neighboring BSs.

When the active BS 220 is connected to the MN 200, the active BS 220 receives link up trigger information from the layer 2, recognizes that the MN 200 is within its region, and transfers the buffered packets to the MN 200. Since the MN 200 moves to the active BS 220 as expected, the passive BS 230 is no longer required. Therefore, the active BS 220 sends a second message MSG02 to the passive BS 230 make it transit back to the normal BS state.

The passive BS 230 sends a second message acknowledgement MSG02_ACK, informs of receiving the second message MSG02 to the active BS 220, and transits back to the normal BS state.

When the MN 200 connected to the active BS 220 resets a path of packets destined for the MN 200 through the mobile IPv4, the anchor BS 210 must terminate a path for forwarding packets to the active BS 220. The present invention suggests two methods of terminating the forwarding path as follows.

First, the MN 200 that receives service from the active BS 220 transmits a registration request message to a home agent HA 240 via the active BS 220. Thereafter, the active BS 220 receives a registration response message from the HA 240 in response to the registration request message and sends a fifth message MSG05 to the anchor BS 210 to request termination of the forwarding path. The fifth message MSG05 includes an IP address of the MN 200. The anchor BS 210 which receives the fifth message MSG05 keeps forwarding the fifth message MSG05 to the previous anchor BSs based on the routing tables to terminate the forwarding path.

Second, the active BS 220 (or an FA located in the active BS 220) transfers the registration request message of the MN 200 to the HA 240 and a fourth message MSG04. The fourth message MSG04 includes the IP address of the MN 200 and an IP address of the active BS 220 that transfers the fourth message MSG04 and the registration request message.

The HA 240 which receives the registration request message and the fourth message MSG04 transmits the registration response message to the MN 200 and simultaneously transmits the fourth message MSG04 to a previous CoA. The anchor BS 210 which receives the fourth message MSG04 from the HA 240 compares the IP address of the active BS 220 included in the fourth message MSG04 with its IP address, and, if the IP address are identical to each other, disregards the fourth message MSG04. If the IP addresses are not identical to each other, the anchor BS 210 transmits the fourth message MSG04 to a neighboring BS based on the routing tables and terminates the forwarding path.

The active BS 220 which receives the registration response message from the HA 240 transits a serving BS state.

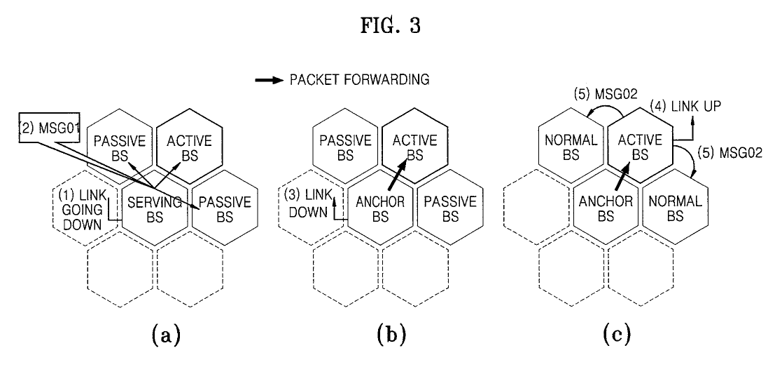

FIG. 3 illustrates state transitions of BSs according to the movement of an MN according to an embodiment of the present invention. Referring to FIG. 3a, a serving BS acquires link going down trigger information according to the movement of the MN, transmits a first message MSG01 including information on an active BS and a passive BS obtained from the link going down trigger information to neighboring BSs, and defines the active BS and the passive BS.

Referring to FIG. 3b, when the MN moves to a different domain region, the serving BS receives the link going down trigger information, transits an anchor BS state, and forwards packets destined for the MN to the active BS.

Referring to FIG. 3c, when the MN moves to the active BS, the active BS acquires link going up trigger information, and transmits the packets forwarded from the anchor BS to the MN. Since the MN moves to the active BS as expected, the passive BS is no longer required. Therefore, the active BS transmits a second message MSG02 to the passive BS, and the passive BS transits to a normal BS state.

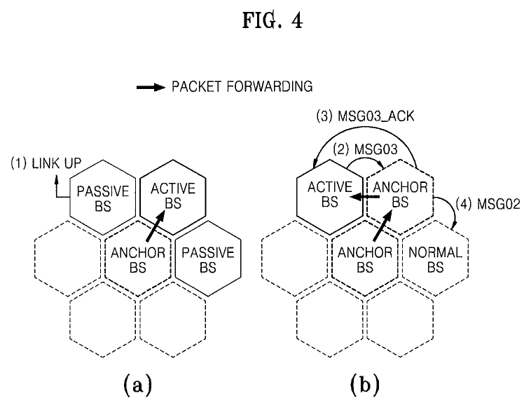

FIG. 4 illustrates a method of forwarding packets when an MN does not move to a domain of an expected BS but a domain of another BS according to an embodiment of the present invention.

When a movement expectation of an MN using link going down trigger information is wrong, or the MN receives service not from an expected active BS but another BS due to an abrupt turn of the MN, it is necessary to compensate for these exceptions.

Information on a BS that will provide service to the MN is acquired from trigger link going down information of layer 2. A lot of researches have suggested to expect a BS to which the MN will move based on the trigger information of layer 2. However, uncertainty of a wireless environment and a user's random movement reduce reliability of the expectation.

Therefore, the present invention defines a passive BS to compensate for these exceptions. The present invention assumes that a future movement direction of the MN can be suggested although the expectation of a future BS has no 100% reliability based on the trigger information of layer 2, and defines that the passive BS having a hexagonal cell configuration neighbors both active BS and serving BS.

Referring to FIG. 4a, when the MN does not move to the active BS but the passive BS, the passive BS generates link up trigger information. The passive BS can identify a currently connected MN based on a MAC address of the MN included in the link up trigger information.

Referring to FIG. 4b, the passive BS which receives the link up trigger information transits to an active BS state, sends a third message MSG03 to the previous active BS of an MN identified through a first message MSG01, and receives buffered packets of the MN from the previous active BS. The previous active BS which receives the third message MSG03 sends a third message acknowledgement MSG03_ACK, transits an anchor BS state, forwards packets destined for the MN to a new active BS, sends a second message MSG02 to another passive BS that is no longer required, and makes the passive BS transits to a normal BS state.

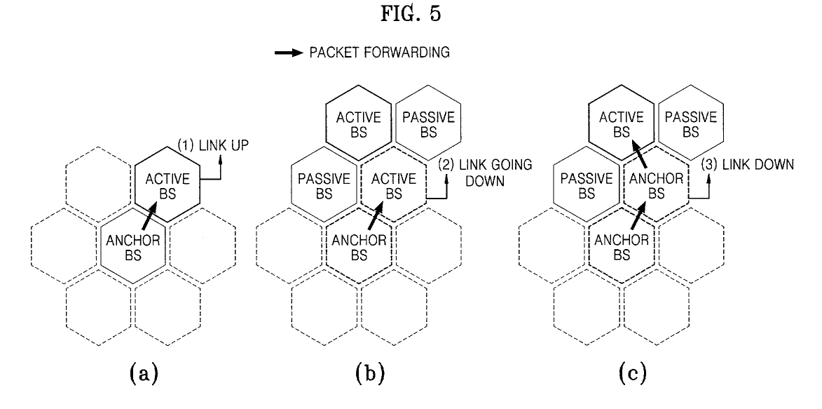

FIG. 5 illustrates operations of transmitting/receiving packets in an MN without resetting a packet path through a mobile Ipv4 according to an embodiment of the present invention.

Referring to FIG. 5a, packets destined for the MN are buffered in an active BS via an anchor BS and transferred to the MN when the active BS acquires link up trigger information.

Referring to FIG. 5b, when the MN moves to another BS, the active BS acquires link going down trigger information, and sets new active BS and passive BS.

Referring to FIG. 5c, when the active BS acquires the link down trigger information, the active BS transits an anchor BS state and forwards the packets destined for the MN to the active BS.

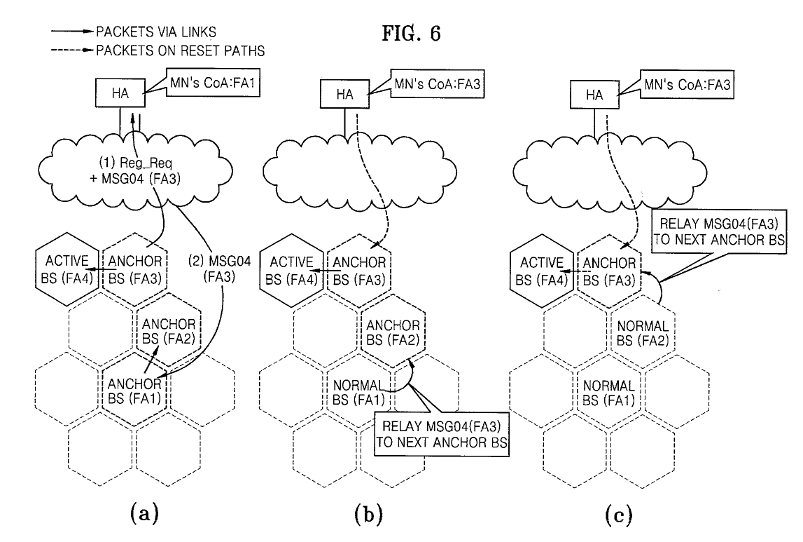

FIG. 6 illustrates operations of terminating a forwarding path in an MN after resetting a packet path through a mobile Ipv4 according to an embodiment of the present invention.

Referring to FIG. 6a, the MN transmits a registration request message through the mobile IPv4 to a HA via a FA3 located in a BS, and moves to a domain of FA4. The FA3 sends the registration request message and a fourth message MSG04.

The HA which receives the registration request message and the fourth message MSG04 sends a registration response message to the MN and simultaneously sends the fourth message MSG04 to a previous CoA, i.e., FA1.

Referring to FIG. 6b, a BS (in which the FA1 is located) which receives the fourth message MSG04 through the HA compares an IP address of a BS included in the fourth message MSG04 with its IP address, and, if the IP address are identical to each other, disregards the fourth message MSG04. If the IP addresses are not identical to each other, the BS transmits the fourth message MSG04 to a neighboring BS (in which a FA2 is located) based on a forwarding routing table for the MN, terminates the forwarding path, and deletes its state information on an MN and the forwarding routing table.

Referring to FIG. 6c, the BS in which the FA2 which receives the fourth message MSG04 is located compares the IP address of the BS included in the fourth message MSG04 with its IP address, transmits the fourth message MSG04 to a BS in which a FA3 on a forwarding path is located, and terminates the forwarding path. The BS in which the FA3 which receives the fourth message MSG04 is located compares the IP address of the BS included in the fourth message MSG04 with its IP address, recognizes that the fourth message MSG04 is a message transmitted by itself, and disregards the fourth message MSG04.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, an MN can avoid packet loss during handover over partial mesh network. Also, the present invention defines a Passive BS to avoid packet loss due to an erroneous expectation of a potential BS based on layer 2 trigger information in wireless media. Since the MN does not join the packet forwarding processes, there are no additional messages in a wireless section, thereby not increasing resource consumption in the wireless section, and minimizing a path change through a Mobile IPv4, so that an existing Mobile IPv4 can be effectively used.

1. A method of forwarding packets in a wireless Internet network in which base stations (BS) of neighboring domains are one-to-one connected via links to avoid packet loss, the method comprising:
(a) based on first trigger information of a layer 2 obtained when a mobile node (MN) moves from a domain of a currently connected first BS to another domain, expecting a second BS of the domain to which the MN moves;
(b) transmitting a first message including expectation information to BSs of neighboring domains;
(c) if the first BS acquires second trigger information of the layer 2 indicating a disconnection between the first BS and the MN, forwarding packets destined for the MN to the second BS through the links; and
(d) if the second BS buffers the packets forwarded from the first BS and third trigger information of the layer 2 indicating a connection between the second BS and the MN, transferring the buffered packets to the MN.

2. A method of forwarding packets in a wireless Internet network in which BSs of neighboring domains are one-to-one connected via links to avoid packet loss due to an erroneous expectation, the method comprising:
(a) based on first trigger information of a layer 2 obtained when a mobile node (MN) moves from a domain of a currently connected first BS to another domain, expecting a second BS of the domain to which the MN moves;
(b) transmitting a first message including expectation information to BSs of neighboring domains;
(c) if the first BS acquires second trigger information of the layer 2 indicating a disconnection between the first BS and the MN, forwarding packets destined for the MN to the second BS through the links; and
(d) if a third BS neighboring both the first BS and the second BS acquires third trigger information of the layer 2 indicating a connection between the third BS and the MN, requesting the second BS to forward the buffered packets based on information on the second BS included in the first message and receiving the buffered packets.

3. The method of claim 1, further comprising:
(e) the second BS transmitting a registration request message requesting a registration of the MN to a home agent (HA) and receiving a registration response message;
(f) the second BS transmitting the registration response message to the first BS and requesting the first BS to terminate a forwarding path.

4. The method of claim 1, wherein the first message includes information on layer 2 address and 3 layer address of the MN, profile information on the service connection of the MN, and information on the second BS of the domain to which the MN moves.

5. The method of claim 1, further comprising: (g) the second BS to which the MN moves transmitting an agent advertisement message in which a common Ethernet address is set as a source Ethernet address.

6. A method of resetting a path of packets forwarded via at least one BS through links in a wireless Internet network in which BSs of neighboring domains are one-to-one connected via links, the method comprising:
(a) when an MN moves from a domain including a first BS to another domain including a second BS, transmitting a fourth message including a registration request message of the MN and an IP address of the second BS to an HA through the second BS;
(b) the HA transmitting the fourth message to the first BS corresponding to a previous care-of-address (CoA); and
(c) the first BS and Bs on a packet forwarding path to the MN comparing the IP address of the second BS included in the fourth message with their IP addresses, if the IP addresses are different from each other, terminating the forwarding path to the MN and transmitting the fourth message to a next BS on the forwarding path, and, if the IP addresses are identical to each other, disregarding the fourth message.

7. The method of claim 6, wherein operation (b) comprises: transmitting a registration response message in which a CoA of the MN is set as the second BS to the MN in response to the registration request message.

8. The method of claim 6, wherein operation (c) comprises:
(c1) the first BS receiving the fourth message from the HA and comparing the IP address of the BS included in the fourth message with its IP address,
(c2) if the IP addresses are different from each other, terminating the forwarding path for the MN, and transmitting the fourth message to the next BS on the forwarding path based on a routing table for the MN;
(c3) the BS which receives the fourth message on the forwarding path comparing the IP address of the BS included in the fourth message with its IP address, and the IP addresses are different from each other, terminating the forwarding path for the MN and transmitting the fourth message to a next BS; and
(c4) when the fourth message on the forwarding path is transmitted to the first BS, if it is determined that the first BS transmits the fourth message, the first BS disregarding the fourth message.

9. A method of transiting states of BSs in a wireless Internet network in which BSs of neighboring domains are one-to-one connected via links, the method comprising:
(a) based on first trigger information of a layer 2 obtained when an MN moves from a domain of a first serving BS that provides service to the MN to another domain, expecting a second BS of the domain to which the MN moves, and transiting the expected second Bs to an active BS state;
(b) setting third BSs neighboring the second active BS and the first serving BS to passive BS states;
(c) if second trigger information of the layer 2 indicating a disconnection between the MN and the first serving BS is acquired, transiting the first serving BS to an anchor BS state to forward packets destined for the MN to the second active BS; and
(d) if third trigger information of the layer 2 indicating a connection between the MN and the second active BS is acquired, transiting the third passive BSs to normal BS states.

10. The method of claim 9, further comprising: (e) if the third trigger information of the layer 2 indicating a connection between the MN and the third passive BSs is acquired, the third passive BSs transiting to active BS states and the second active BS transiting to the anchor BS state.

11. The method of claim 2, wherein the first message includes information on layer 2 address and 3 layer address of the MN, profile information on the service connection of the MN, and information on the second BS of the domain to which the MN moves.

12. The method of claim 2, further comprising: (g) the second BS to which the MN moves transmitting an agent advertisement message in which a common Ethernet address is set as a source Ethernet address.
